(19) United States
(12) Patent Application Publication
(10) Pub. No.: US 2004/0040868 A1
(43) Pub. Date: Mar. 4, 2004

(54) Microfabricated sensor arrays for multi-component analysis in minute volumes

(76) Inventors: John D. DeNuzzio, Chapel Hill, NC (US); Erno Lindner, Germantown, TN (US); Robert E. Gyurcsanyi, Budapest (HU)

Correspondence Address: Christian C. Michel, Roylance, Abrams, Berdo & Goodman, L.L.P., Suite 600, 1300 19th Street, N.W., Washington, DC, 20036, US

(21) Appl. No.: 10/464,801

(22) Filed: Jun. 19, 2003

Related U.S. Application Data
(60) Provisional application No. 60/389,504, filed on Jun. 19, 2002.
(60) Provisional application No. 60/389,894, filed on Jun. 20, 2002.

(51) Int. Cl. G01N 27/26

(52) U.S. Cl. 205/792; 204/403.13; 204/435

(57) ABSTRACT

Sensors and methods of making the same are disclosed. Sensors are microfabricated with multiple working electrodes and a single, common counter electrode. The multiple working electrodes can be fabricated in different geometrical configurations for advantageously analyzing multiple components simultaneously in the same microcell sensor. Furthermore, sensors according to certain embodiments of the invention include openings to allow photometric analysis along with electroanalytical methods.

### FIELD OF THE INVENTION

The present invention is related to sensors used for the analysis of small volumes of liquid samples. In particular, the present invention is related to the combination of optical sensing with multiplexed electrochemical sensing using microfabricated electrochemical manifolds consisting of multiple sensor arrays as working electrodes for multi-component analysis in minute volumes.

### BACKGROUND OF THE INVENTION

Traditional sensor configurations typically allow single analyte detections in a sequential format. These measurements are often single, end-point determinations of analyte levels. Previous attempts at multiplexed analysis in small volume samples have been limited either by the sensitivity of the measurement or by the variety of sensors available. However, new miniaturization technologies enable the manufacture of multiplexed miniaturized arrays of sensors.

Electrodes are widely used tools in analytical chemistry to detect or generate charge separation at interfaces and to create or modify the charge numbers by induced current. As the geometric dimensions of electrodes become progressively smaller, their electrochemical behavior begins to depart from that of large electrodes. Microelectrodes are defined as electrodes whose critical size is in the micrometer range. Microelectrodes have several advantages compared to conventional macroelectrodes. For example, microelectrodes have short response time and permit measurements in very limited solution volumes and in low conductivity media. Furthermore, microelectrodes are known to improve the signal to noise ratio due to the fact that the overall signal scales with size, while unwanted background noise decreases in a non-linear manner as electrode size decreases. In addition, diffusion distances are reduced as electrode sizes decrease, resulting in faster response times. More information on microelectrodes can be found in Stulik, K., Amatore, C., Holub, K., Marecek, V., and Kutner, W., Microelectrodes, Definitions, Characterization and Applications (Technical Report), Pure Appl. Chem., Vol. 73, p. 1483 (2000), which is incorporated herein by reference in its entirety.

However, when microelectrodes are used in the measurement of electric current for analytical purposes (amperometric measurements) the measured currents are often in the lower nano-ampere (nA) range. Therefore, the application of microelectrodes often requires special instrumentation and measurement conditions, such as the use of Faraday cage, to eliminate the effect of the different sources of noise. To overcome the difficulties related to the measurement of very small currents microelectrode arrays (MEA) are used. Microelectrode arrays consist of a bundle of interconnected microelectrodes. The amperometric current of a MEA is the sum of the currents of the individual microelectrodes. Under certain geometrical conditions MEAs have all the advantages of single microelectrodes without the difficulties in measuring extremely small currents.

Thin film, photolithographic fabrication procedures of microelectrode arrays provide novel opportunities in the design and application of microelectrode arrays. Microfabricated electrode arrays are mass produced with highly reproducible geometrical shapes. Electrode arrays can be configured as narrow spikes for plunging into the myocardium or shaped as 2-D plaques for measurements on the epicardial surface.

Most microfabricated electrodes are made on solid substrates such as silicon or glass. However they can also be manufactured on flexible substrates such as Kapton®. Lindner, E., et al., Flexible (Kapton-based) Microsensor Arrays of High Stability for Cardiovascular Applications, J. Chem. Soc. Faraday. Trans., 1993, 89(2), 361-367. Fabrication on flexible films compared to glass or silicon substrates has numerous advantages. The fabrication cost per sensor for flexible films is much lower compared to silicon substrates. Also, Kapton® substrates with sputtered gold coating and chromium or titanium adhesion layers are commercially available in rolls. Thus, only the dimensions of the photolithographic equipment limits the size of the substrate.

### SUMMARY OF THE INVENTION

Embodiments of the present invention include microfabricated electrochemical manifolds with multiplexed microelectrode array sensors as multiple working electrodes and method of fabricating the same having different geometrical features (such as, for example micro-disc arrays, microband arrays, and interdigitated arrays) on rigid or flexible substrates, such as glass or Kapton®, preferably using fabrication methods such as thin film photolithography or thick film lamination.

An aspect of embodiments of the invention is to combine multiplexed microelectrode array working electrodes preferably made of, for example, Gold (Au), Platinum (Pt) or various forms of carbon with a planar reference electrode preferably made of, for example, Silver (Ag) or Silver Chloride (AgCl) to form a planar electrochemical cell for voltammetric measurements in a few microliters of sample liquid. Microelectrode array working electrodes can also be combined with a planar counter electrode preferably made of, for example, Gold (Au), Platinum (Pt) or graphite.

Another aspect of embodiments of the invention is to integrate several microelectrode arrays in combination with a single planar reference electrode into a single planar amperometric cell for multi-component analysis. Such analysis could preferably simultaneously measure O₂, H₂O₂, and NADH, for example.

According to another aspect of embodiments of the invention, the surface of the planar electrochemical manifolds (planar amperometric microcells) is modified for improved selectivity, reduced nonspecific binding or the indirect detection of non-electroactive analytes. Such surface modifications can include, for example, the addition of a size exclusion layer or an immobilized glucose oxidase layer or both onto the surface of the microelectrode array working electrodes, or a polyethylene oxide layer over the complete electrochemical manifold, among other possibilities.

According to another aspect of embodiments of the invention, electrochemical protein patterning can be used in combination with an embodiment of the present invention for the deposition of selectivity modifying layers over the microelectrode array working electrode surfaces. After the microfabrication of the substrate electrode array, there are advantageously no geometrical constraints and no necessity for further micromanipulation processes, such as microwriting, microstamping, or micropipetting. The technical difficulties regarding the alignment of masks and destructive procedures (such as UV light) and chemistries (such as organic solvents) are also thereby avoided.

The electrochemical manifold (planar amperometric microcells) according to embodiments of the invention can include an applied thin hydrophilic membrane layer (such as hydrogel or porous alumina) on the bottom of the electrochemical cell with multiplexed microarray working electrodes and planar reference and/or counter electrodes to provide homogeneous distribution of minute sample volumes in the well over the electrode surfaces and control the analyte transport to the sensor surface. The hydrophilic membrane may be impregnated with the necessary chemicals in solid or lyophilized form when the planar electrochemical manifold (amperometric cell) is directed to single use, such as single use enzyme activity sensors.

A further aspect of embodiments of the invention is the combination of the multiplexed electrochemical detection with optical detection in a single planar microcell. A planar amperometric microcell is preferably integrated in the path of electromagnetic radiation between a light source and an appropriate optical detector, such as, for example, a photomultiplyer tube, a photodiode array or a charge coupled device. Advantageously, the planar amperometric cell is preferably integrated on the tip of a bundle of optical fiber or onto the wall of a spectrophotometric cuvette for combined optical and electrochemical measurement.

Yet another aspect of embodiments of the invention is to integrate the planar optical/electrochemical cell with multiple microelectrode array sensors on the bottom of microtiter plate wells and cell culture plates.

Microelectrode array sensors according to embodiments of the present invention can also be integrated with microfabricated sampling, sample transport and separation units.

### BRIEF DESCRIPTION OF THE DRAWINGS

The invention will be more readily understood with reference to the embodiments thereof illustrated in the attached drawing figures, in which:

FIG. 1 illustrates an amperometric microcell fabricated with thin-film microfabrication technology, having a single working electrode (W) comprising a microelectrode array; and a single counter/reference electrode (R).

FIGS. 2a-2c illustrate amperometric cells according to several embodiments of the present invention having multiple working electrodes and a single common counter electrode, and also providing an area for optical measurements in addition to electrochemical analysis;

FIG. 3 illustrates a microtiter plate with integrated amperometric cells;

FIGS. 4a-4c illustrate combinations of working electrodes having different geometrical configurations in a single microcell according to various embodiments of the present invention; and

FIG. 5 is a cross section of a sensor device according to an embodiment of the present invention.

In the figures, it will be understood that like numerals refer to like features and structures.

### DETAILED DESCRIPTION OF THE PREFERRED EMBODIMENTS

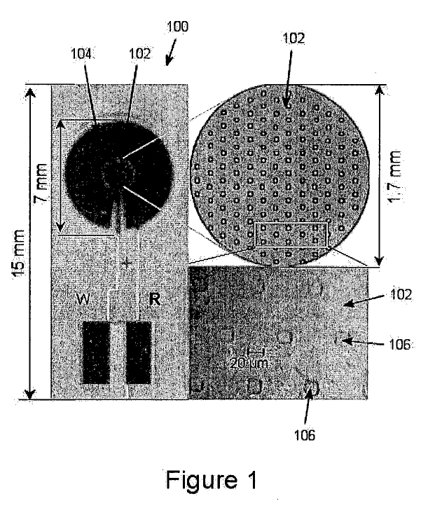

Embodiments of the present invention will now be described with reference to the attached drawing figures. FIG. 1 is an amperometric microcell 100 fabricated with thin-film microfabrication technology. The microcell 100 comprises two electrodes, a working electrode 102, and a counter electrode 104. The working electrode 102 surface is preferably 1.7 mm in diameter, and is patterned into a microelectrode array. The microelectrode array comprises preferably 190 square shaped microelectrodes 106 which are preferably 20 μm×20 μm each. The individual microelectrodes 106 are arranged in a hexagonal fashion with preferably 80 μm distance between the individual sites. In another preferred arrangement (not shown) the microelectrode array consists of 330 circular shaped microelectrodes 10 μm in diameter each. The individual microelectrodes 106 are arranged in a hexagonal fashion with preferably 90 μm distance between the individual sites.

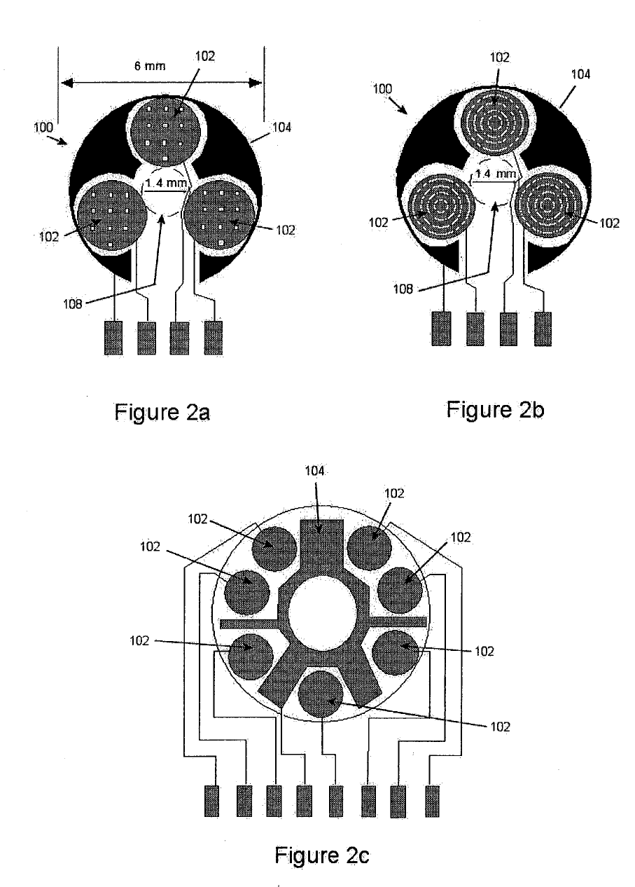

FIG. 2a is a microcell according to an embodiment of the invention comprising multiple working electrodes 102. The microelectrodes 102 are configured in a microdisc format patterned into a microelectrode array. Also, an opening 108 is provided in the center of the microcell 100 to allow light to pass through a sample. In this manner, photometric analysis can be performed in addition to electroanalytical measurements. FIG. 2b is a microcell according to an embodiment of the invention having multiple working electrodes 102 configured in a microband format. FIG. 2c is a microcell according to yet another embodiment of the invention having seven working electrodes 102 arranged around common counter electrode 104.

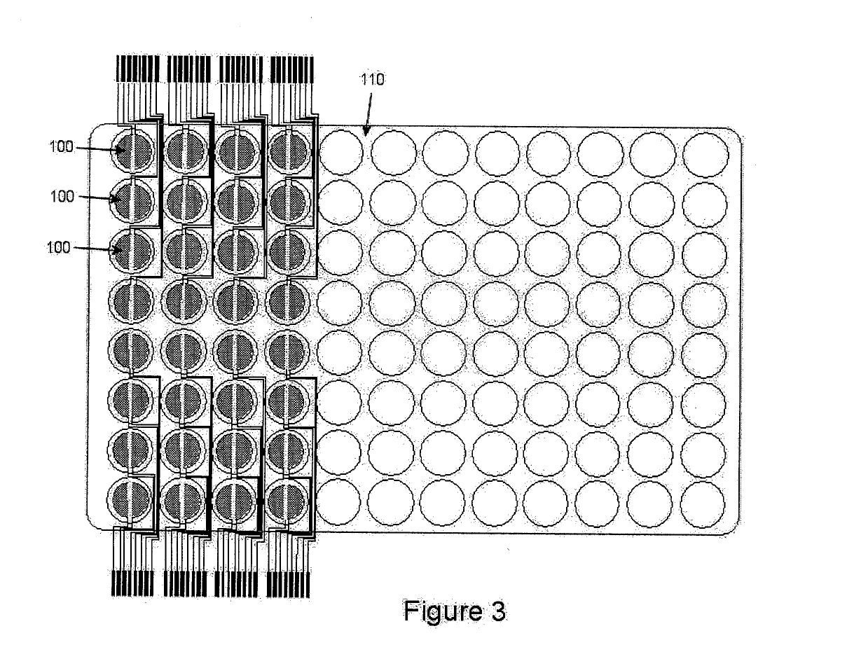

FIG. 3 illustrates a preferred embodiment of the present invention. A plurality of microcells 100 are arranged at the base of the wells of a microtiter plate 110. The working electrodes are preferably patterned into microelectrode arrays. Further embodiments of the invention include microcells 100 integrated with an optical detection aperture. The optical detection system comprises a light source and a detection system in which the amperometric microcell serves as a cuvette. Preferably, the planar amperometric cell is integrated with a fiber optic bundle aligned with an aperture or opening 108 to perform photometric measurements.

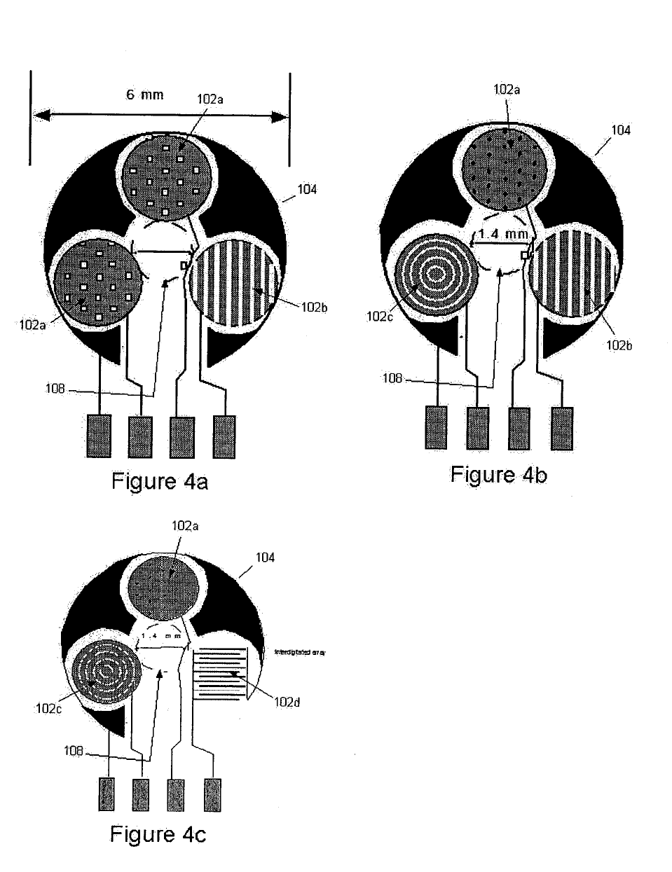

FIGS. 4a-4c illustrate embodiments of the present invention having multiple working electrodes 102 of different configurations in the same microcell 100. Microcells of this design advantageously allow the microcell to analyze multiple components simultaneously, depending on the configuration of the plurality of microelectrodes 102 included. As an example, FIG. 4a illustrates a microcell 100 having two working electrodes arranged in a microdisc array configuration 102a, along with a third working electrode arranged in a linear microband array configuration 102c. FIG. 4b illustrates a microcell 100 having one working electrode arranged in a microdisc array configuration 102a, a second working electrode configured in a linear microband array configuration 102b, and a third working electrode configured in a concentric circular microband array configuration 102c. FIG. 4c illustrates a microcell 100 having one working electrode arranged in a microdisc array configuration 102a, a second working electrode arranged in a concentric circular microband array configuration 102c, and a third working electrode arranged in an interdigitated array configuration 102d. Interdigitated microelectrodes are advantageous in that the working electrode 102d is interwoven with the counter electrode 104. Thus, the distance between the working 102d and counter electrode 104 is minimized. This configuration is known to improve the signal to noise ratio and minimize the IR drop between the electrodes.

Each of the embodiments shown also includes an opening 108 for photometric analysis. Optimetric measurements which can be taken include fluorescence, absorbance, vibrational, luminescent, and refractive index, among others. Furthermore, photometric measurements can include direct measurement of, for instance, infrared energy or fluorescence, as well is indirect measurement of a marker dye or the like. Also, it should be understood that sensors according to embodiments of the invention are not limited to electrochemical and optical measurement, but rather can easily include tests for additional properties, such as conductance, viscosity, and temperature, among others.

Embodiments of the invention described herein capitalize on new miniaturization technologies to create new highly sensitive, highly versatile sensor arrays that are especially useful for analyzing biologically derived samples. By employing microfabrication methods, multiple sensor types including electrochemical and optical (among others) can be combined to measure multiple analytes in minute volumes of complex samples. Furthermore, the enhanced sensitivity of these sensor arrays permit reliable, real-time, continuous monitoring of analytes.

The combination of various electrochemical, photometric, and other measurement made possible with embodiments of the present invention results in a powerful analytical tool capable of measuring multiple properties of an analyte, as well as properties of multiple analytes simultaneously, and in real time. As an example, with a sensor according to an embodiment of the present invention, it is possible to measure glucose consumption, enzyme activity, and viability through optical measurements, all simultaneously from the same sample.

The above description is intended to illustrate that various combinations of types of working electrodes can advantageously be combined to allow a plurality of sample components to be analyzed simultaneously. Oxygen, hydrogen peroxide, NADH and NADPH are among the analytes, which can be measured using a sensor according to embodiments of the present invention. Of course, those of skill in the art will readily appreciate that any substance susceptible of electroanalytical analyses is intended to be within the scope of the present invention. Organic and inorganic compounds which can be oxidized or reduced on the platinum, gold, and different forms of carbon (among others) microelectrode arrays. For example, drugs such as ascorbic acid and p-acetamino phenol can be measured. Also, enzyme activities can be indirectly measured through the measurement of reaction partners or products of enzyme catalyzed reactions. For example, glucose oxidase can be measured through oxygen consumption or H₂O₂ generation. Of course these examples are merely intended to be exemplary in nature, and are not intended to be inclusive of all of the possibilities of the invention.

Furthermore, combining the electrochemical sensor arrays with other detection technologies such as optical sensors creates new ways to measure complex processes in small samples and in real time. For example, viability of living cells in culture can be monitored via oxygen consumption in microwell plates with a fluorescent oxygen sensitive dye sensor. For a general discussing of monitoring oxygen consumption in microwell plates, see, e.g., Timmins, Mark; Monitoring Adherent Cell Proliferation on BD Oxygen Biosensor Systems; BD Biosciences Discovery Labware; Tech. Bulletin #447 (http://www.bdbiosciences.com/discovery_labware/Products/drug_discovery/oxygen_biosensor_system/pdf/TB447.pdf). By combining optical and electrochemical sensors in a miniaturized format, it is possible to monitor cell function, metabolism, and viability by measuring multiple analytes such as oxygen and metabolic markers like enzyme activity simultaneously, and in real time.

While it should be readily understood that the invention is not limited to a particular type of liquid, the invention is particularly suited to testing biologically derived liquids, including blood, urine, saliva, sweat, and tears, among others. Also, it should be understood that embodiments of the invention are capable of testing not only liquids, but also properties of non-liquids such as biological cells and tissue. Also, embodiments of the invention are capable of interrogating the contents of cells.

According to further embodiments of the invention, working electrodes are modified to broaden the possible applications and enhance the performance of electrochemical analysis. In particular, the working electrodes can advantageously be patterned with specific receptors or exposed to special surface treatments. Examples of receptors include electron transfer agents such as enzymes, or affinity capture species such as antibodies, among others. Surface treatments include, among other things, plasma treatment, or materials to enhance the sensors selectivity through hydrophilicity or hydrophobicity, surface charge e.g., anionic and cationic exchangers or size exclusion.

Among the electroanalytical methods anticipated to be employed in microcells according to embodiments of the invention are voltametric methods, including linear sweep voltammetry (LSV), chrono amperometry (CA), pulse voltammetry (PV), differential pulse voltammetry (DPV), square wave voltammetry, and AC voltammetry. Also contemplated are conductimetric methods, potentiometric methods, stripping methods, and coulometric methods. One of skill in the art will appreciate that the above list of methods is not exhaustive, but is intended to be exemplary in nature.

The optical port 108 included in preferred embodiments of the invention allows a microcell 100 to be used for photometric measurements, including but not limited to UV-VIS spectrophotometry, spectroflourimetry, measurement of light scattering, polarization techniques, lifetime measurements, chemiluminescence methods, and electrochemiluminescence methods.

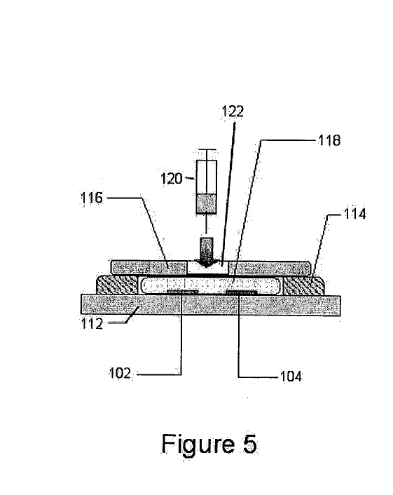

FIG. 5 illustrates a cross section of an amperometric microcell according to an embodiment of the invention. The microcell is formed onto a planar substrate 112 that is preferably made of ceramic material. Working electrode 102 and reference electrode 104 are formed on top of the planar substrate 112. It should be noted that a single combined reference electrode and counter electrode can be used with embodiments of the present invention. The combined electrode will work with multiple working electrodes. Insulator 114 and cell top 116 define an enclosed cell volume 118. In certain applications, volume 118 preferably houses a porous membrane to assist sample liquid in being distributed through volume 118, and in particular to come in contact with the electrodes 102, 104. A syringe or comparable device 120 is used to inject sample fluid into volume 118 through an opening 122 in cell top 116.

While the invention herein disclosed has been described by means of specific embodiments and applications thereof, numerous modifications and variations could be made thereto by those skilled in the art without departing from the scope of the invention.

What is claimed is:

1. A microfabricated sensor array comprising:
a first electrode and at least one working electrode selected from the group consisting of microdisk, concentric circular microband, linear microband, and interdigitated array; and
an optical aperture adapted to receive light from a sample liquid.

2. A microfabricated sensor array as in claim 1, further comprising a plurality of working electrodes as multiplexed planar arrays.

3. A microfabricated sensor array as in claim 2, wherein said plurality of working electrodes comprise more than one type selected from the group consisting of microdisk, concentric circular microband, linear microband, and interdigitated array.

4. A microfabricated sensor array as in claim 2, wherein said optical aperture is substantially adjacent to said planar array.

5. A microfabricated sensor array as in claim 1, wherein said first electrode is a counter electrode.

6. A microfabricated sensor array as in claim 5, further comprising a reference electrode.

7. A microfabricated sensor array as in claim 1, wherein said first electrode is a reference electrode.

8. A microfabricated sensor array as in claim 1, wherein said first electrode is a common combined reference/counter-electrode.

9. A microfabricated sensor array as in claim 1, wherein said sample liquid is a biologically derived liquid.

10. A microfabricated sensor array as in claim 1, wherein said sample liquid comprises cells.

11. A microfabricated sensor array as in claim 1, wherein said sample liquid comprises tissue.

12. A microfabricated sensor array as in claim 1, wherein said sample liquid comprises at least one liquid selected from the group consisting of blood, urine, saliva, sweat, and tears.

13. A microfabricated sensor array as in claim 1, further comprising a common counter-electrode.

14. A microfabricated sensor array as in claim 1, wherein said at least one working electrode is adapted to enhance selectivity for a particular analyte.

15. A microfabricated sensor array as in claim 1, wherein said at least one working electrode is patterned with at least one enzyme.

16. A microfabricated sensor array as in claim 1, wherein said at least one working electrode is patterned with at least one antibody.

17. A microfabricated sensor array as in claim 1, wherein said at least one working electrode is patterned with a hydrophilic substance.

18. A microfabricated sensor array as in claim 1, wherein said at least one working electrode is patterned with a hydrophobic substance.

19. A method of fabricating a sensor array comprising the steps of:
forming an electrochemical sensing device comprising a first electrode and at least one working electrode selected from the group consisting of microdisk, concentric circular microband, linear microband, and interdigitated array; and
forming an optical aperture in said sensing device adapted to receive light from a sample liquid in contact with said at least one working electrode.

20. A method of fabricating a sensor array as in claim 19, wherein said sensing device further comprises a plurality of working electrodes arranged as multiplexed planar arrays.

21. A method of fabricating a sensor array as in claim 20, wherein said plurality of working electrodes comprise more than one type selected from the group consisting of microdisk, concentric circular microband, linear microband, and interdigitated array.

22. A method of fabricating a sensor array as in claim 20, wherein said optical aperture is substantially adjacent to said planar array.

23. A method of fabricating a sensor array as in claim 19, wherein said first electrode is a counter electrode.

24. A method of fabricating a sensor array as in claim 23, further comprising a reference electrode.

25. A method of fabricating a sensor array as in claim 19, wherein said first electrode is a reference electrode.

26. A method of fabricating a sensor array as in claim 19, wherein said first electrode is a common combined reference/counter-electrode.

27. A method of fabricating a sensor array as in claim 19, wherein said sample liquid is a biologically derived liquid.

28. A method of fabricating a sensor array as in claim 19, wherein said sample liquid comprises cells.

29. A method of fabricating a sensor array as in claim 19, wherein said sample liquid comprises tissue.

30. A method of fabricating a sensor array as in claim 19, wherein said sample liquid comprises at least one liquid selected from the group consisting of blood, urine, saliva, sweat and tears.

31. A method of fabricating a sensor array as in claim 19, wherein said electrochemical sensing device further comprises a common counter-electrode.

32. A method of fabricating a sensor array as in claim 19, further comprising the step of preparing said at least one working electrode to enhance selectivity for a particular analyte.

33. A microfabricated sensor array as in claim 19, further comprising the step of patterning said at least one working electrode with at least one enzyme.

34. A microfabricated sensor array as in claim 19, further comprising the step of patterning said at least one working electrode with at least one antibody.

35. A microfabricated sensor array as in claim 19, further comprising the step of patterning said at least one working electrode with a hydrophilic substance.

36. A microfabricated sensor array as in claim 19, further comprising the step of patterning said at least one working electrode with a hydrophobic substance.

37. A method of testing a sample liquid comprising the steps of:
adding a sample liquid to an electrochemical sensing device comprising a first electrode and at least one working electrode selected from the group consisting of microdisk, concentric circular microband, linear microband, and interdigitated array;
measuring a signal at each of said at least one working electrodes;
measuring light received through an optical aperture formed into said sensing device in contact with said at least one working electrode.

38. A method of testing a sample liquid as in claim 37, wherein said sensing device further comprises a plurality of working electrodes arranged as multiplexed planar arrays.

39. A method of fabricating a sensor array as in claim 38, wherein said plurality of working electrodes comprise more than one type selected from the group consisting of microdisk, concentric circular microband, linear microband, and interdigitated array.

40. A method of testing a sample liquid as in claim 38, wherein said optical aperture is substantially adjacent to said planar array.

41. A method of testing a sample liquid as in claim 37, wherein said first electrode is a counter electrode.

42. A method of testing a sample liquid as in claim 41, further comprising a reference electrode.

43. A method of testing a sample liquid as in claim 37, wherein said first electrode is a reference electrode.

44. A method of testing a sample liquid as in claim 37, wherein said first electrode is a common combined reference/counter-electrode.

45. A method of testing a sample liquid as in claim 37, wherein said sample liquid is a biologically derived liquid.

46. A method of testing a sample liquid as in claim 38, wherein said sample liquid comprises cells.

47. A method of testing a sample liquid as in claim 38, wherein said sample liquid comprises tissue.

48. A method of testing a sample liquid as in claim 37, wherein said sample liquid comprises at least one liquid selected from the group consisting of blood, urine, saliva, sweat and tears.

49. A method of testing a sample liquid as in claim 37, further comprising the step of chemically modifying said liquid sample.

50. A method of testing a sample liquid as in claim 37, further comprising the step of stabilizing said liquid sample.

51. A method of testing a sample liquid as in claim 37, further comprising the step of irradiating said liquid sample.

52. A method of testing a sample liquid as in claim 37, further comprising the step of ionizing said liquid sample in a buffer.

53. A method of testing a sample liquid as in claim 37, further comprising the step of pretreating said liquid sample by chemically modifying said liquid sample.

54. A method of testing a sample liquid as in claim 37, further comprising the step of pretreating said liquid sample by stabilizing said liquid sample.

55. A method of testing a sample liquid as in claim 37, further comprising the step of pretreating said liquid sample by irradiating said liquid sample.

56. A method of testing a sample liquid as in claim 37, further comprising the step of pretreating said liquid sample by ionizing said liquid sample in a buffer.

57. A method of testing a sample liquid as in claim 37, wherein said step of measuring a signal at each of said at least one working electrodes comprises measuring a potential at each of said electrodes.

58. A method of testing a sample liquid as in claim 37, wherein said step of measuring a signal at each of said at least one working electrodes comprises measuring current at each of said electrodes.

59. A method of testing a sample liquid as in claim 37, wherein said step of measuring light comprises measuring fluorescence.

60. A method of testing a sample liquid as in claim 37, wherein said step of measuring light comprises measuring a refractive index.

61. A method of testing a sample liquid as in claim 37, further comprising determining a viscosity of said sample liquid.

62. A method of testing a sample liquid as in claim 37, further comprising determining a temperature of said sample liquid.

63. A method of testing a sample liquid as in claim 37, wherein said measuring steps further comprise taking a plurality of said measurements over time.
